(19) United States
(12) Patent Application Publication
(10) Pub. No.: US 2006/0140842 A1
(43) Pub. Date: Jun. 29, 2006

(54) Method for modifying nanocharges and applications thereof

(76) Inventors: Fabrice Stassin, Ath (BE); Cedric Calberg, Esneux (BE); Robert Jerome, Jalhay (BE)

Correspondence Address: JACOBSON HOLMAN PLLC, 400 SEVENTH STREET N.W., SUITE 600, WASHINGTON, DC, 20004, US

(21) Appl. No.: 10/559,832

(22) PCT Filed: Apr. 23, 2004
(86) PCT No.: PCT/EP04/04388

§ 371 Date: Dec. 6, 2005

(30) Foreign Application Priority Data
Jun. 6, 2003 (EP) 03076761.0

(51) Int. Cl. C01B 33/26; C08K 9/04

(52) U.S. Cl. 423/328.1; 521/91; 524/445

(57) ABSTRACT

A process for modifying an unmodified clay, in particular a montmorillonite type clay, is characterized in that the clay is intimately mixed with an organomodifier selected from quaternary ammonium salts, siliconated ammonium compounds, highly fluorinated ammonium compounds, phosphonium salts, sulphonium salts, precursors of said salts and mixtures of at least two of said compounds, in the presence of carbon dioxide under pressure.

The invention relates to a process for modifying nanofillers, in particular unmodified clays of the montmorillonite type, and to its applications.

Current interest in the preparation of nanocomposite polymer materials is increasing. Such materials are the result of intimately dispersing nanofillers such as clays in polymer matrices. Dispersing clay sheets on a nanoscopic scale allows materials with enhanced mechanical, thermal, rheological and barrier properties to be produced. To optimize the dispersion of clays in the form of individual sheets (delamination, exfoliation) or of small stacks of sheets as much as possible, it is necessary to use organomodified clays that can reduce the marked hydrophilic nature of the clays and thus render the fillers relatively compatible with the polymers, which are generally characterized by a marked hydrophobic nature. To this end, lamellar silicates (phyllosilicates) are being used ever more frequently, principally because they are easy to use and widely available on the market at a reasonable price. The best known example of such clays is natural montmorillonite (i.e. not organomodified). Organomodified clays do not exist in the natural state and must thus be prepared by synthesis.

Such nanofillers or organomodified clays are prepared in polar solvents such as water or alcohols such as methanol over periods of several hours and at moderately high temperatures, usually 70° C. During such reactions, a quaternary ammonium, sulphonium or phosphonium salt is brought into the presence of a natural clay having sodium ions ionically bonded to oxygen counter-ions (O⁻Na⁺) on the surface of each sheet. Following reaction, the ammonium, sulphonium or phosphonium ion is exchanged with the sodium and is therefore ionically fixed to the surface of the clay sheet. After the modification reaction in water or alcohol, the wet clay has to be filtered and then dried, requiring considerable energy expenditure because of the high latent heat of vaporization of the solvents used, which constitutes a major disadvantage of this “wet” method. Further, following exchange, the contaminated water has to be purified before discharge. That method of preparation in water or an alcohol also has a serious limitation as regards the restricted range of organomodifiers (of the ammonium, phosphonium type) which can be used. In fact, the success of the wet method for modifying clays is highly dependent on the original solubility of the organomodifier in the medium in which the clay is to be dispersed during modification thereof. Further, the modification of clays by highly fluorinated or siliconated organomodifiers would necessitate the use of suitable solvents which are usually not cheap, thereby further cutting the profitability of such a process.

As a result, the present invention aims to overcome all of the limitations of the wet process by proposing a flexible, rapid and economic process for modifying clays which at no point uses a conventional solvent.

To this end, according to the present invention, the unmodified clay is intimately mixed with an organomodifier selected from quaternary ammonium salts, sulphonium salts, phosphonium salts, siliconated ammonium compounds, highly fluorinated ammonium compounds, quaternary ammonium compound precursors and mixtures of at least two of said compounds, in the presence of carbon dioxide under pressure, the clay and organomodifier advantageously being intimately mixed before being brought into contact with C0₂ under pressure.

This method, termed a “dry” method, is consequently based on the use of compressed carbon dioxide and preferably brought to a supercritical condition as the medium for dispersing the clay and for modification thereof. Dispersing clays in the supercritical CO₂ is relatively easy because of the low viscosity of supercritical fluids. Further, the integration of molecules into the inter-sheet space of the clay (impregnation step) profits from the high diffusivity of mixtures based on supercritical fluids. Since said impregnation step is accompanied by a negative variation in volume, the process will be favoured by operating at high pressure, such as that routinely used during processes employing supercritical or highly compressed fluids, i.e. at pressures of 50 to 300 bars and at a temperature of 40° C. to 50° C., advantageously about 40° C.

Examples will be given below concerning the modification of virgin or unmodified clays using the CO₂ process of the invention. More particularly, Example 6 pertains to the preparation of organomodified clays not starting from an ammonium compound added as is, but starting from its “parent” molecules, i.e. an amine and an alkyl halide. It is in fact a process starting from the “raw” ingredients, which has the advantage of generating a clay with a higher added value.

Clearly, these examples are given solely by way of illustration and do not in any way limit the scope of the invention.

### EXAMPLE 1

### Modification of Virgin Clay by Various Alkylammonium Salts

Unmodified clay (Cloisite® N⁺; 2 to 5 g) was intimately mixed with a slight excess (1.1 equivalent) of each of the three quaternary ammonium salts indicated in Table 5 [sic] below then poured into a high pressure reactor with a volume of 100 ml. the temperature and CO₂ pressure in the chamber were then adjusted and maintained at the desired values (40° C. and 200 bars). Ion exchange was carried out with constant stirring (700 rpm) during the time period indicated in Table 1. After reaction, the reactor was slowly depressurized. In order to characterize the recovered powder, it was washed with water, with a water/methanol mixture (1/1 volume/volume) and with methanol, then finally dried. The mass increase was calculated by TGA and the powder was characterized by X ray diffraction. The use of the solvents noted above was only justified because non-exchanged ammonium has to be removed in order to provide better characterization during analyses of the clay which has been modified in supercritical CO₂ using the dry method.

TABLE 1

| | | | | Nature of | | Percentage |
|---|---|---|---|---|---|---|
| | | | | quaternary | Interplanar | ion |
| Exp | P | | Time | ammonium | spacing (Å) | exchange |
| n^{o} | (bar) | t (° C.) | (h) | salt | (d₀₀₁)^{c} | (%)^{b} |
| 1 | 200 | 40 | 4 | TEACl.nH₂O^{a} | 14.2 | 69 |
| 2 | 200 | 40 | 6 | TBAHS^{a} | 16.8 | 89 |
| 3 | 200 | 40 | 4 | DDDMABr^{a} | 18.4 | 77 |
| ^{a}The abbreviations TEACl, TBAHS, DDDMABr respectively designate tetraethylammonium chloride, tetrabutylammonium hydrogen sulphate and didodecyldimethylammonium bromide; the three experiments were thus carried out in the presence of three different quaternary ammonium salts carrying alkyl chains of various length. | | | | | | |
| ^{b}The percentage ion exchange is the ratio between the quantity of quaternary ammonium cations fixed on the surface of the clay sheets (determined by thermogravimetric analysis (TGA)) and the maximum theoretical quantity of said cations assuming complete ion exchange (determined initially from the exchange capacity of Cloisite Na⁺, namely 92 meq/100 g of clay). This percentage thus corresponds to the percentage of Na⁺ ions effectively displaced by ammonium | | | | | | |
| # ions during the exchange reaction. | | | | | | |

^{c}The interplanar spacing d₀₀₁ measures the mean distance separating two sheets of clay following modification of said clay by an alkylammonium. This distance is measured by X ray diffraction. The native clay (or virgin clay or non-organomodified clay) has an interplanar spacing of 11.8 Å

The following observations were made from the results obtained:
TGA analysis showed that quaternary ammonium cations had been incorporated into the natural clay being examined;
the exchanged cations were chemisorbed on the surface of the clay sheets, so that washing with water or methanol (good solvents for the tested salts) could not eliminate them;
following exchange, the interplanar spacing of the organomodified Cloisite was significantly increased since it moved from 11.8 Å for the unmodified clay to 14.2, 16.8 and 18.4 Å in experiments 1, 2 and 3;
the bulkier the quaternary ammonium cation, the larger the interplanar spacing following modification;
appreciable degrees of modification were obtained in relatively short time periods.

### EXAMPLE 2

### Study of Exchange Kinetics and the Effect of Pressure on the Modification of Clays by Alkylammonium Compounds in Supercritical CO₂

TABLE 2

| | | Interplanar | Percentage ion |
|---|---|---|---|
| Exp No | Time (h) | spacing (Å | exchange (%) |
| 1 | 4 | 18.4 | 77 |
| 2 | 1 | 18.4 | 86 |
| 3 | 0.25 | 18.4 | 65 |

The three experiments were carried out using the operating procedure of Example 1, i.e. at 40° C. and at a pressure of 200 bars. The organomodifying agent used was DDDMABr, i.e. didodecyldimethylammonium bromide.

Experiment number 3 demonstrated that almost all of the sodium ions on the surface of the clay sheets had been exchanged in a very short period. This result is even more surprising because the modifying agent employed is a very bulky quaternary ammonium compound (carrying C₁₂ alkyl chains). It should be noted in this respect that the kinetics when modifying clays in hot water, the kinetics are of the order of several hours.

### EXAMPLE 3

Study of the influence of CO₂ pressure on ion exchange between clay and alkylammonium in supercritical CO₂

TABLE 3

| | | Interplanar | Percentage ion |
|---|---|---|---|
| Exp No | Pressure (bar) | spacing (Å | exchange (%) |
| 1 | 50 | 18.4 | 93 |
| 2 | 100 | 18.4 | 97 |
| 3 | 200 | 18.4 | 81 |

The three experiments were carried out using the operating procedure of Example 1, i.e. at 40° C. and 200 bars, for 10 minutes. For each of the three experiments, 0.84 g of DDDMABr (didodecyldimethylammonium bromide) was intimately mixed with 2 g of Cloisite® Na⁺ and the mixture then underwent treatment with supercritical CO₂.

The results obtained demonstrate the existence of an optimum pressure for carrying out ion exchange. This observation is, however, rather difficult to interpret. Intuitively, it is easy to see that an increase in pressure would facilitate the incorporation of quaternary ammonium ions between the clay sheets. This hypothesis is all the more plausible because the incorporation of molecules into a host matrix is accompanied by a reduction in the volume of the system (negative ΔV) and thus should be favoured by an increase in pressure according to the law of equilibriums. In contrast, the reverse phenomenon is observed above 100 bars. This surprising observation could be the result of an increase in the polarity of CO₂ at high pressure. Secondly, this polarity could influence the dissolved ammonium/adsorbed ammonium equilibrium. The more polar the CO₂, the more soluble the ammonium salt will be in it and it will have a lower tendency to adsorb on the walls of the clay, thereby slowing the exchange reaction.

### EXAMPLE 4

### Study of the Influence of the Quantity of Organomodifier Incorporated Into the Clay on the Interplanar Spacing of the Clay Which has been Modified in Supercritical CO₂

TABLE 4

| | Quantity of | | Conversion of ion |
|---|---|---|---|
| Exp No | DDDMABr (g) | Interplanar spacing (Å | exchange reaction (%) |
| 1 | 0.041 | 12.5 | 100 |
| 2 | 0.116 | 12.9 | 100 |
| 3 | 0.84 | 18.4 | 86 |

The three experiments were carried out using the operating procedure of Example 1, i.e. at 40° C. and 200 bars, for one hour. Each experiment used 2 g of Cloisite® Na⁺.

Table 4 clearly shows the effect of the quantity of ammonium exchanged with the clay on the interplanar spacing thereof. It is important to note that this distance is only substantially modified when the ammonium salt added is in a quantity close to the cationic exchange capacity of the virgin clay. This observation may be explained by a modification in the orientation of the alkyl chains carried by the quaternary ammonium ions during subsequent addition of ammonium salts. Initially, these chains tend to be disposed parallel to the plane of the clay sheets, inducing a slight separation of the sheets. As soon as the organic layer covers the entire surface of the sheets, the chains have to superimpose themselves to allow the incorporation of more cations. The position of the alkyl chains is modified and they tend to adopt an orientation which is increasingly perpendicular to the planes of the clay sheets. The maximum separation therebetween can thus only be obtained when almost all of the alkali ions have been displaced by ammonium ions.

### EXAMPLE 5

### Modification in Supercritical CO₂ of Virgin Clays by Siliconated or Highly Fluorinated Ammonium Compounds

The ammonium compounds used in Examples 1 to 4 are in fact hydrophilic ammonium compounds, i.e. alkylammonium salts. Such ammonium compounds may also be used during the modification of clay fillers in aqueous media, which is not the case when using hydrophobic ammonium compounds. In effect, the ammonium compounds are less soluble in the medium and are difficult to integrate into and exchange within the clay sheets. Highly fluorinated derivatives and siliconated derivatives occupy an important place among hydrophobic ammonium compounds as they open up real opportunities for the effective preparation of nanocomposites of fluorinated or siliconated polymers. Two examples will be given below of the preparation of said novel clays in supercritical CO₂, a medium known to be a relatively good solvent for silicones and highly fluorinated derivatives.

a) Modification by an Ammonium Compound Carrying a PDMS Segment

Prior synthesis of siliconated ammonium compound: 10 g of poly(dimethylsiloxane) (PDMS) carrying an amino (−NH₂) termination at its two ends (Mn=850 g/mole) were dissolved in 50 ml of tetrahydrofuran (THF) in the presence of 3.4 ml of iodobutane. The reaction mixture was heated at 50° C. for 65 hours. The reaction yield, measured after purification, was 75%.

0.55 g of this modified PDMS and 1 g of Cloisite®Na⁺ were then introduced into the reactor and the procedure of Example 6 was carried out. Ion exchange was carried out at 40° C. over 3 hours and at a pressure of 100 bars of CO₂. The interplanar spacing obtained was 16.5 Å and the ion exchange percentage was 60%.

Conversion of natural Cloisite (Cloisite Na⁺) into organomodified Cloisite was lower than in the experiments reported in Examples 1 to 4. However, the degree of exchange was sufficient to induce a large modification in the interplanar spacing.

b) Modification by Ammonium Carrying a Highly Fluorinated Segment

Prior synthesis of highly fluorinated ammonium compound: 10 g of iodotetrahydroperfluorooctane in 50 ml of THF was dissolved in the presence of 5 ml of triethylamine. The reaction was carried out at 50° C. for 65 hours. Tetrahydroperfluorooctyltriethylammonium iodide was recovered by evaporating to dryness and purifying.

0.52 g of the fluorinated ammonium compound obtained and 1 g of Cloisite® Na⁺ were introduced into the reactor and the procedure of Example 1 was followed. Ion exchange was carried out at 40° C. for 3 hours at a pressure of 100 bars of supercritical CO₂. The interplanar spacing obtained was 13.1 Å and the percentage ion exchange was 32%.

As in the case of the siliconated ammonium compound, the degree of cationic exchange was not high. This tends to demonstrate that the more soluble the organophilic cation is in supercritical CO₂, the harder it is to incorporate it into the clay.

### EXAMPLE 6

Integration upstream of a process for modifying a virgin clay in supercritical CO₂ Rather than start from a mixture of ammonium salt and natural clay, as already mentioned above, this example pertains to the preparation of organomodified clays starting from a virgin clay and quaternary ammonium compound precursors, i.e. the corresponding amine and a suitable alkyl halide.

The treatment, resulting from a step for synthesis of the ammonium compound followed by its incorporation and exchange within natural clay sheets, was carried out at 40° C. for 24 hours at a pressure of 300 bars of supercritical C0₂ in the presence of 0.37 ml of bromooctane, 1.4 ml of tridodecylamine and 2 g of Cloisite® Na⁺. The operating procedure described in Example 1 was then carried out. The interplanar spacing obtained was 20.3 Å and the degree of ion exchange was 63%.

This example clearly shows that it is entirely possible to synthesize the modifying agent and incorporate it into a natural clay in a single step. It is important to point out that the rate of quaternization of the amine in the presence of an alkyl halide appears to be faster in supercritical CO₂ than in THF, for example. In fact, the yield of this reaction is a minimum of 63% in supercritical CO₂ after 24 hours reaction, while it reaches a value of 75% after 65 hours at 50° C. in THF.

While the present process pertains to the modification of unmodified clays in general, it is particularly suited to the modification of montmorillonite type clays. The principle of this modification resides in the excellent transport properties of CO₂, and in particular of supercritical CO₂, allowing good impregnation of the interplanar space by the alkylammonium compounds and therefore facilitating ion exchange at the surface of the clay sheets. This modification of native clays in supercritical CO₂ thus renders them organophilic and far more compatible with polymer matrices, thus facilitating their dispersion and the preparation of nanocomposites with mainly exfoliated clay fillers. It should be noted that the use of (supercritical) CO₂ can also readily allow the preparation of modified clays by ammonium compounds carrying siliconated or highly fluorinated segments.

It should be understood that the present invention is not in any way limited to the implementations described above and that modifications may be made without departing from the scope of the present invention.

1. A process for modifying an unmodified clay, in particular a montmorillonite type clay, characterized in that the clay is intimately mixed with an organomodifier selected from quaternary ammonium salts, sulphonium salts, phosphonium salts, siliconated ammonium compounds, highly fluorinated ammonium compounds, precursors of said salts and mixtures of at least two of said compounds, in the presence of carbon dioxide (CO₂) under pressure.

2. The process according to claim 1, characterized in that the CO₂ is in the supercritical state.

3. The process according to claim 1, characterized in that the clay and the organomodifier are intimately mixed before being brought into contact with CO₂ under pressure.

4. A The process according to claim 1, characterized in that the quaternary ammonium salt employed is an alkylammonium salt.

5. The process according to claim 4, characterized in that the alkylammonium salt is selected from the group comprising tetraethylammonium chloride, tetrabutylammonium hydrogen sulphate, didodecyldimethylammonium bromide and mixtures thereof.

6. The process according to claim 1, characterized in that the siliconated ammonium compound used is a modified poly(dimethylsiloxane).

7. A The process according to claim 1, characterized in that the highly fluorinated ammonium compound used is tetrahydroperfluorooctyltriethylammonium iodide.

8. The process according to claim 1, characterized in that the quaternary ammonium compound precursors are an amine and an alkyl halide.

9. The process according to claim 1, characterized in that the CO₂ is at a pressure of 50 to 300 bars and at a temperature of 40° C. to 50° C., advantageously about 40° C.

10. The biodegradable polyester foam prepared in the presence of an organomodified clay using the process according to claim 1, having a homogeneous, substantially regular, fine and closed cellular structure.

11. Use of a biodegradable polyester foam prepared in the presence of an organomodified clay using the process of claims 1, for the manufacture of exterior coatings, drinks and fast food packaging, bottles, disposable cutlery, thermoformed articles, fibres, films, mixtures with starch, bioresorbable medical implants, agricultural transplantation pots, plant labels and fixings, meditrays, biomaterials and re-absorbable patches.
